(19) United States
(12) Patent Application Publication
(10) Pub. No.: US 2025/0018389 A1
(43) Pub. Date: Jan. 16, 2025

(54) DETECTION CHIP ASSEMBLY TOOL, LIQUID INJECTION APPARATUS AND METHOD, ELECTRONIC DEVICE, AND MEDIUM

(71) Applicant: BGI SHENZHEN, Guangdong (CN)

(72) Inventors: Junlei YAO, Guangdong (CN); Yuning ZHANG, Guangdong (CN); Yong WANG, Guangdong (CN); Mengmeng ZHANG, Guangdong (CN); Quanxin YUN, Guangdong (CN); Yuxiang LI, Guangdong (CN); Yuliang DONG, Guangdong (CN); Wenwei ZHANG, Guangdong (CN)

(21) Appl. No.: 18/710,180

(22) PCT Filed: Nov. 17, 2021
(86) PCT No.: PCT/CN2021/131232

§ 371 Date: May 14, 2024

(51) Int. Cl. B01L 3/00

(52) U.S. Cl. CPC B01L 3/50273; B01L 2200/027; B01L 2200/12; B01L 2300/041; B01L 2300/0681; B01L 2400/049

(57) ABSTRACT

The present application provides a detection chip assembly tool, a liquid injection apparatus and method, an electronic device, and a medium. The tool is mounted on a vacuumizing assembly, and comprises: a base mounted on a detection chip. The base is provided with a reaction cavity covering the detection chip and a fluid channel communicated with the reaction cavity, and is further provided with a liquid inlet groove structure communicated with the fluid channel and having a buffer solution injected. When the detection chip is filled with the buffer solution, the vacuumizing assembly is started to discharge air in the detection chip assembly tool, in response to the vacuumizing assembly vacuumizing, pressure relief is performed, and the buffer solution in the liquid inlet groove structure flows into the reaction cavity along the fluid channel under the action of negative pressure so as to fill the detection chip.

### TECHNICAL FIELD

The present application relates to the field of gene testing, particularly concerning a microwell array detection chip assembly tool, a liquid injection apparatus, and method, an electronic device and a medium.

### BACKGROUND

The working principle of detection chips, such as microwell array sequencing chips, is as follows: in a cavity filled with electrochemical buffer solution, divide the cavity into two smaller chambers by an insulating membrane with nanoscale pores (such as a phospholipid bilayer, artificial membrane, etc.), when voltage is applied to the electrolyte chamber, ions or other small molecular substances can pass through the pores, forming a stable, detectable ion current. By controlling the size and surface characteristics of the nanopores, the applied voltage, and the conditions of the solution, biomolecules with different types can be detected.

The microwell array sequencing chip primarily consists of thousands of microwells, with the whole inner walls of the microwell array made of hydrophobic materials, and the filling of the electrochemical buffer solution is an indispensable condition for sequencing.

Changing the hydrophilicity and hydrophobicity of the inner walls of the microwell array to reach a hydrophilic state, so that the electrochemical buffer solution can permeate into the microwell array by means of hydrophilicity. However, the methods of changing the surface properties of materials are relatively complex and costly. Additionally, some types of sequencing chips require hydrophobic on the surface of microwells, hence this way cannot meet the buffer solution filling requirements for hydrophobic microwell array sequencing chips.

Therefore, the current common method for filling the buffer solution in microwell array sequencing chips involves dispensing the buffer solution over the microwell array by using a pipette gun, followed by placing it in a vacuum chamber, then vacuumizing until the liquid filling is complete.

However, the current method according to the above filling buffer solution has the following deficiencies:

1. Both of using a pipette gun for liquid injection and the starting, stopping of the vacuum pump require manual operation, which increases labor cost and decreases filling efficiency and accuracy.

2. Because the liquid is injected before vacuumizing, it is impossible to achieve an absolute vacuum inside the microwells, preventing the buffer solution from being completely filled.

3. During vacuumizing, some air bubbles remain in the buffer solution, forming a gas-liquid mixture, which can affect subsequent sequencing.

### CONTENT OF THE PRESENT INVENTION

The present application primarily aims to provide a detection chip assembly tool, a liquid injection apparatus, and method, an electronic device, and a medium to improve the above deficiencies in the prior art.

The present application resolves the above technical problem by the following technical solutions:
As one aspect of the present application, a detection chip assembly tool is provided and mounted on a vacuumizing assembly;
The detection chip assembly tool comprises:
a base mounted on a detection chip, the base is provided with a reaction cavity covering the detection chip and a fluid channel communicated with the reaction cavity, and is further provided with a inlet groove structure communicated with the fluid channel and having a buffer solution injected;
wherein, when the detection chip is filled with the buffer solution, the vacuumizing assembly is started to discharge air in the detection chip assembly tool; in response to the vacuumizing assembly vacuumizing, pressure relief is performed, and the buffer solution in the inlet groove structure flows into the reaction cavity along the fluid channel under the action of negative pressure so as to fill the detection chip.

As an optional embodiment, the base comprises a cover plate and a bottom plate, where the cover plate is mounted on the bottom plate;
the cover plate is provided with a recessed area, and the bottom plate is provided with a cut-out area, and the bottom of the recessed area together with the cut-out area form the reaction cavity;
the bottom plate is provided with a fluid groove, the fluid groove together with the bottom the of the cover plate form the fluid channel;
the top of the cover plate is provided with the inlet groove structure.

As an optional embodiment, the bottom plate is also provided with an air storage groove, and the air storage groove together with the bottom of the cover plate forms an air storage chamber;
the air storage chamber is communicated with the reaction cavity and is used to store the residual air that is pushed in by the buffer solution when the buffer solution fills into the reaction cavity.
As an optional embodiment, the detection chip assembly tool further comprises a fixed base;

The detection chip is mounted on the fixed base.

As another aspect of the present application, a liquid injection apparatus for the detection chip is provided, comprising a liquid injection assembly, a vacuumizing assembly, a control module, and the detection chip assembly tool as described above;
the detection chip assembly tool is mounted on the vacuumizing assembly, and the liquid injection assembly is used to inject buffer solution into the inlet groove structure;
the control module is configured to start the vacuumizing assembly to discharge air in the detection chip assembly tool when filling the detection chip with buffer solution;
the control module is also configured to respond to detect out a preset vacuum condition being established in the detection chip assembly tool, then start the liquid injection assembly to inject the buffer solution into the inlet groove structure and control the vacuumizing assembly to release pressure, and the buffer solution in the inlet groove structure flows into the reaction cavity along the fluid channel under the action of negative pressure so as to fill the detection chip.

As an optional embodiment, the vacuumizing assembly comprises a chip assembly fixing plate, a vacuum tank, a vacuum tank cover plate, a suction pipeline, a vacuum pump, and a vacuum valve;
the detection chip assembly tool is mounted on the chip assembly fixing plate;
the chip assembly fixing plate is installed inside the vacuum tank;
the vacuum tank cover plate is mounted on the vacuum tank;
one end of the suction pipeline is positioned inside the vacuum tank;
the vacuum pump is installed on the suction pipeline and is used to extract air in the vacuum tank;
the vacuum valve is connected with the vacuum pump and is communicated with the control module.

As an optional embodiment, the vacuumizing assembly further comprises a vacuum detection pressure gauge, a pressure-release speed regulating valve, and a gas filter;
the vacuum detection pressure gauge is communicated with the control module and is used to detect the pressure inside the vacuum tank;
the pressure-release speed regulating valve is connected with the vacuum valve and is used to release pressure and adjust the speed of the pressure releasing;
the gas filter is installed on the suction pipeline.

As an optional embodiment, the liquid injection assembly comprises an injection needle, an injection needle holder, an injection pump, an injection pump inlet electromagnetic valve, an injection pump outlet electromagnetic valve, and a connecting tube;
the injection needle is mounted on the injection needle holder and is used to inject the buffer solution into the inlet groove structure;
the injection needle holder is positioned inside the vacuum tank;
the injection pump is connected with the injection needle by means of the connecting tube and is used to deliver buffer solution into the injection needle;
the injection pump inlet electromagnetic valve is connected with the inlet of the injection pump and is communicated with the control module;
the injection pump outlet electromagnetic valve is connected with the outlet of the injection pump and is communicated with the control module.

As an optional embodiment, the liquid injection assembly further comprises an adjustment screw rod and a guide rod;
the adjustment screw rod is configured on the injection needle holder and is used to adjust the distance between the injection needle and the inlet groove structure;
the guide rod is positioned between the chip assembly fixing plate and the injection needle holder.

As an optional embodiment, the liquid injection assembly further comprises a buffer solution container;

the buffer solution container is connected with the injection pump by means of the connecting tube and is used to contain the buffer solution.

As another aspect of the present application, a method of injecting liquid into the detection chip is provided, which utilizes the liquid injection apparatus for the detection chip as described above, and the method of injecting liquid comprises:
start the vacuumizing assembly to discharge air in the detection chip assembly tool when the detection chip is filled with buffer solution;
respond to detect out a preset vacuum condition being established in the detection chip assembly tool, then start the liquid injection assembly to inject buffer solution into the inlet groove structure and control the vacuumizing assembly to release pressure, and the buffer solution in the inlet groove structure flows into the reaction cavity along the fluid channel under the action of negative pressure so as to fill the detection chip.

As another aspect of the present application, an electronic device is provided, comprising a memory, a processor, and a computer program stored in the memory that can be run on the processor, when the processor executes the computer program, the aforementioned method of injecting liquid into the detection chip is implemented.

As another aspect of the present application, a computer-readable medium is provided, which contains computer instructions, when the computer instructions are executed by a processor, the aforementioned method of injecting liquid into the detection chip is implemented.

Based on the contents of the present application, those skilled in the art can understand other aspects of the present application.

The significant advantages achieved by the present application include:

The present application effectively utilizes the mode of vacuumizing and then automatically injecting liquid, to make the gas in the microwell array of the detection chip does not pass through the solution, thereby effectively prevents a gas-liquid mixtures being generated, additionally, it does not need to manually operate by using a pipette gun, and enable automatically vacuumizing, automatically injecting liquid, and automatically release pressure can be achieved with a single button operation, which reduce cost, also minimize staff contacting with chemicals, thereby significantly improve the efficiency and accuracy of liquid injection into the detection chip.

### BRIEF DESCRIPTION OF THE DRAWINGS

On the basis of reading the detailed description of the embodiments of the present application in conjunction with the figures, the features and the advantages of the present application can be better understood. In the figures, the components may not be sketched exactly according to scale, and components with similar relevant characteristics or features may have the same or similar reference numerals.

FIG. 1A is a schematic of the first assembly of the detection chip assembly tool according to an embodiment of the present application.

FIG. 1B is a schematic of the second assembly of a detection chip assembly tool according to an embodiment of the present application.

FIG. 2A is a structural schematic of the base and the detection chip of the detection chip assembly tool according to an embodiment of the present application.

FIG. 2B is an assembly schematic of the base of the detection chip assembly tool according to an embodiment of the present application.

FIG. 3 is a structural schematic of a microwell array detection chip.

FIG. 4A is a schematic of the gas in the microwells of the detection chip after using the traditional liquid injection method.

FIG. 4B is a schematic of the gas in the microwells of the detection chip after using the detection chip assembly tool provided by the present application.

FIG. 5 is a schematic of the module structure of the liquid injection apparatus for the detection chip according to another embodiment of the present application.

FIG. 6A is a front structural schematic of the pump valve assembly of the liquid injection apparatus for the detection chip according to another embodiment of the present application.

FIG. 6B is a rear structural schematic of the pump valve assembly of the liquid injection apparatus for the detection chip according to another embodiment of the present application.

FIG. 7 is an assembly schematic of the vacuumizing assembly and the liquid injection assembly of the liquid injection apparatus for the detection chip according to another embodiment of the present application.

FIG. 8 is a schematic of the electronic control interface for the liquid injection apparatus for the detection chip according to another embodiment of the present application.

FIG. 9 is a flowchart schematic of the method for liquid injection into a detection chip according to another embodiment of the present application.

FIG. 10 is a structural schematic of an electronic device implementing the method of injecting liquid into the detection chip according to another embodiment of the present application.

### REFERENCE NUMERAL DESCRIPTION

Injection pump outlet electromagnetic valve 1;

Injection pump inlet electromagnetic valve 2;

Injection pump 3; Vacuum pump 4;

Vacuum valve 5: Electronic control board 6;

Mounting fixing plate 7; Vacuum tank cover plate 8;

Injection needle 9; Injection needle holder 10;

Adjustment screw rod 11; Guide rod 12;

Chip assembly fixing plate 13; Chip assembly 14;

Vacuum tank 15; Base 161;

Cover plate 1611; Recessed area 16111;

Bottom plate 1612; Cut-out area 16121;

Fluid groove 16122; Air storage groove 16123;

Inlet groove structure 1613; Fastening screw 162;

Fixture base 163; Reaction cavity 164;

Detection chip 17; Microwell 171;

Buffer solution container 24; Vacuum detection pressure gauge 25;

Pressure-release speed regulating valve 26; Gas filter 27.

### DETAILED DESCRIPTION OF THE PREFERRED EMBODIMENT

The present application is further illustrated by way of examples, but it is not limited to the described examples.

It should be noted that references in the specification to “one embodiment,” “an optional embodiment,” “another embodiment,” etc., indicate that the described embodiments may include specific features, structures, or characteristics, but not every embodiment necessarily includes the particular feature, structure, or characteristic. Moreover, such phrases are not necessarily referring to the same embodiments. Furthermore, when specific features, structures, or characteristics are described in conjunction with the embodiments, it is within the knowledge of those skilled in the relevant fields to implement such features, structures, or characteristics in conjunction with other embodiments whether or not explicitly described.

In the description of the present application, it is understood that terms such as “center,” “lateral,” “top,” “bottom,” “left,” “right,” “vertical,” “horizontal,” “upper,” “lower,” “inner,” “outer,” etc., indicate orientations or positional relationships based on those shown in the figures, these terms are used merely for convenience in describing the application and for simplifying the description, and do not imply that the referred devices or elements must have a specific orientation, be constructed and operated in a specific orientation, therefore these terms should not be construed as limiting the application. Additionally, the terms “first,” “second,” are used merely for descriptive purposes and should not be interpreted as indicating or implying relative importance, or implying the quantity of the technical features as indicated. Therefore, the features defined as “first,” “second” can explicitly or implicitly include one or more such features. In the descriptions of the present application, unless otherwise specified, the term “multiple” means two or more. Furthermore, the term “comprise/comprising,” and any of its variations, are intended to convey a non-exclusive inclusion.

In the descriptions of the present application, it should be noted that unless explicitly defined and limited, terms such as “installed/mounted,” “communicated,” and “connected” should be understood in a broad sense, for example, these terms could denote fixed connections or detachable connections, and could be integrally connected; and they might represent mechanical connections or electrical connections; connections could be direct or indirect by an intermediary medium, and could involve internal communications within two components. Those of ordinary skill in the art can understand the specific meanings of these terms in the present application based on the context and specific circumstances.

The terminology used here is intended merely for describing specific embodiments, not be intended to limit the exemplary implementations. Unless explicitly specified otherwise in the context, the singular forms “a,” “an,” and “one” should also be understood to include the plural form. It should also be understood that the term “comprise/comprising” and/or “include/including,” as used herein, specifies the presence of stated features, integers, steps, operations, elements, and/or components, but does not preclude the presence or addition of one or more other features, integers, steps, operations, elements, components, and/or their combinations.

A detection chip, for example the microwell array sequencing chip, primarily consists of thousands of microwells, with all the inner walls of the microwell array are made of hydrophobic materials, the filling of the electrochemical buffer solution is an indispensable condition for sequencing.

Currently, the filling of buffer solution for the sequencing chip is implemented by a method of firstly injecting liquid and then creating a vacuum, and this process uses a sealing pad or by other method to make the microwell array to form a liquid storage groove, and adds buffer solution onto the surface of the microwell array, and the sealing device is used to keep the solution on the surface of the sequencing chip, afterwards, the chip is placed inside a vacuum tank then draw a vacuum. At this time, the air inside the microwell array is extracted along with the negative pressure in the vacuum tank increasing, until the pressure inside the microwells equals the pressure at the liquid surface, however, due to the inability to achieve an absolute vacuum and the gravitational force of the liquid on the surface of the microwell array, that is, vacuum tank pressure=microwell internal pressure+liquid gravity, the vacuum level inside the microwells array is less than that the vacuum level in the vacuum tank, which means some air cannot be discharged. Furthermore, as discharging the air inside the microwells needs to enter into the surface buffer solution, which cause forming microbubbles, and due to the action of surface tension, part of larger bubbles will be burst because of pressure change, while part of smaller bubbles remain suspending in the buffer solution and cannot be discharge, resulting in a gas-liquid mixture, thereby cause the buffer solution in the microwells array become a gas-liquid mixture after pressure release, which affect the working stability of the sequencing chip.

To overcome the existing deficiencies as detailed above, this embodiment provides a liquid injection apparatus for the detection chip, comprising a liquid injection assembly, a vacuumizing assembly, a control module, and the detection chip assembly tool as described above; the detection chip assembly tool is mounted on the vacuumizing assembly, and the liquid injection assembly is used to inject the buffer solution into the inlet groove structure; the control module is configured to start the vacuumizing assembly to discharge air in the detection chip assembly tool when filling the detection chip with buffer solution; the control module is also configured to respond to detect out a preset vacuum condition being established in the detection chip assembly tool, then start the liquid injection assembly to inject the buffer solution into the inlet groove structure and control the vacuumizing assembly to release pressure, and the buffer solution in the inlet groove structure flows into the reaction cavity along the fluid channel under the action of negative pressure so as to fill the detection chip.

In this example, the detection chip is preferably a sequencing chip, but it is not limited to sequencing chips alone; it may also be a detection chip used for other biological or chemical detection, and it can make corresponding adjustments or selections according to actual or anticipated needs. Besides being applied in the field of sequencing detection, the liquid injection apparatus can also be applied in various other areas such as protein analysis, single-cell analysis, and drug screening, based on implementing the functions as described above, it can be adapted or selected correspondingly according to actual or potential requirements.

In this example, we effectively utilize the method of vacuumizing followed by automatic liquid injection to make the gas in the microwell array of the detection chip does not pass through the solution, thereby effectively prevent gas-liquid mixture being generated, additionally, the process does not need to manually operate using a pipette gun, and enable automatically vacuumizing, automatically injecting liquid, and automatically releasing pressure can be implemented with a single button, which reduce cost, and also minimizes staff contacting with chemicals, thereby significantly improve the efficiency and accuracy of liquid injection into the detection chip.

As an example, the liquid injection apparatus for the detection chip provided by this example primarily comprises a detection chip assembly tool, a vacuumizing assembly, a liquid injection assembly, and a control module.

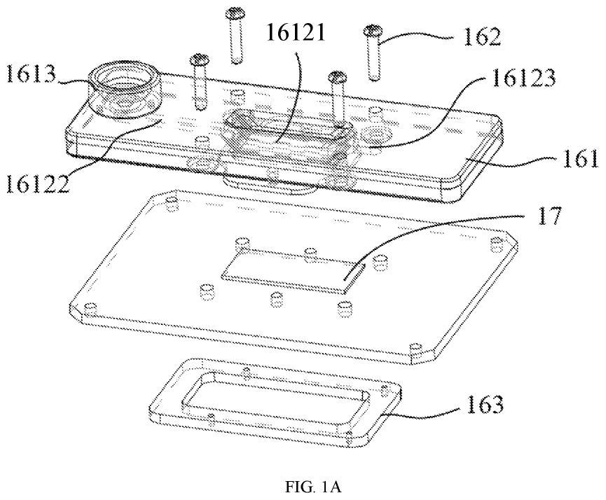

As shown in FIGS. 1A and 1B, the detection chip assembly tool primarily comprises a base 161, several fastening screws 162, and a fixture base 163.

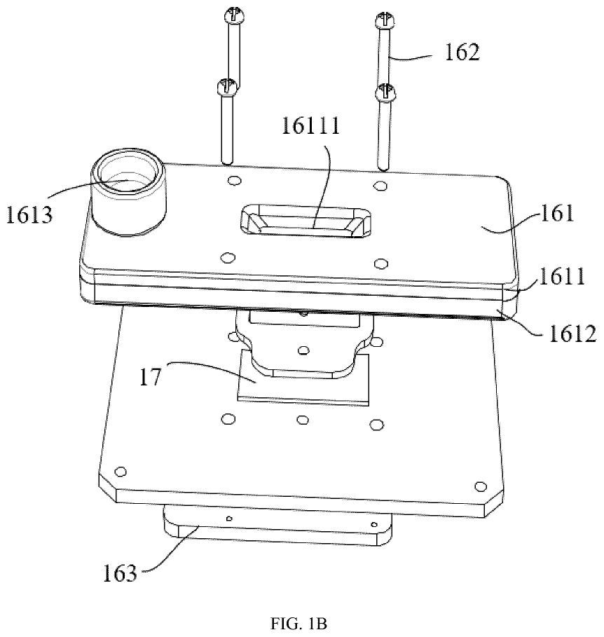

As illustrated in FIG. 2B, the base 161 mainly comprises a cover plate 1611 and a bottom plate 1612, wherein the cover plate 1611 is mounted on the bottom plate 1612, the cover plate 1611 is provided with a recessed area 16111, and the bottom plate 1612 is provided with a cut-out area 16121, and the bottom of the recessed area 16111 (i.e. the bottom of the cover plate 1611) together with the cut-out area 16121 form the reaction cavity 164, the bottom plate 1612 is provided with a fluid groove 16122, the fluid groove 16122 together with the bottom the of the cover plate 1611 form the fluid channel, and the top of the cover plate 1611 is provided with the inlet groove structure 163.

As an optional embodiment, as shown in FIGS. 2A and 2B, the bottom plate 1612 is also provided with an air storage groove 16123, and the air storage groove 16123 together with the bottom of the cover plate 1611 form a sealed air storage chamber, the air storage chamber is communicated with the reaction cavity 164.

As shown in FIGS. 1A, 2A, and 7, the detection chip 17 is installed together with the base 161 and the fixture base 163 by using several fastening screws 162 to form the chip assembly 14, wherein, thereby creating a sealed reaction cavity 164, a fluid channel, and an air storage chamber.

In this example, the specific number of fastening screws 162 or the method of securing the detection chip is not explicitly defined, any method that can achieve corresponding fixing effect can be adjusted and selected according to practical needs.

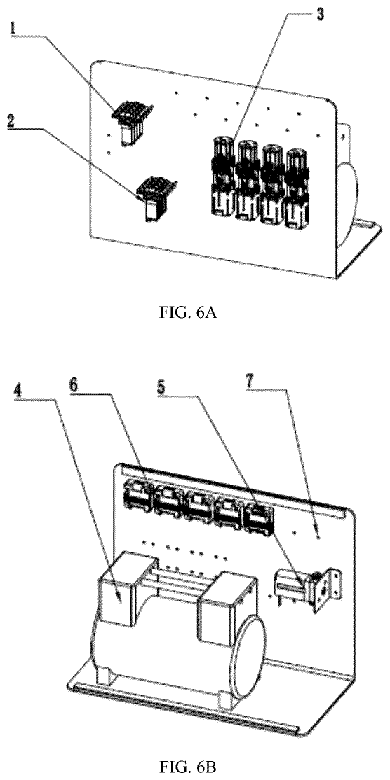

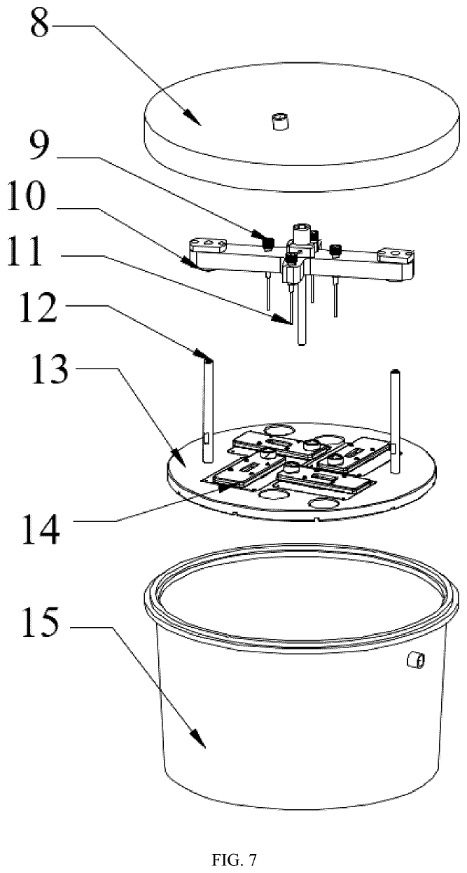

As shown in FIGS. 6B and 7, the vacuumizing assembly primarily comprises a chip assembly fixing plate 13, a vacuum tank 15, a vacuum tank cover plate 8, a suction pipeline (not shown in the figure), a vacuum pump 4, and a vacuum valve 5.

The chip assembly 14 is mounted on the chip assembly fixing plate 13, the chip assembly fixing plate 13 is installed inside the vacuum tank 15; the vacuum tank cover plate 8 is mounted on the vacuum tank 15, one end of the suction pipeline is positioned inside the vacuum tank 15, the vacuum pump 4 is installed on the suction pipeline and is used to extract air in the vacuum tank 15, the vacuum valve 5 is connected with the vacuum pump 4, and control to start the vacuum pump 4 by controlling the closing of the vacuum valve to extract air in the vacuum tank 15.

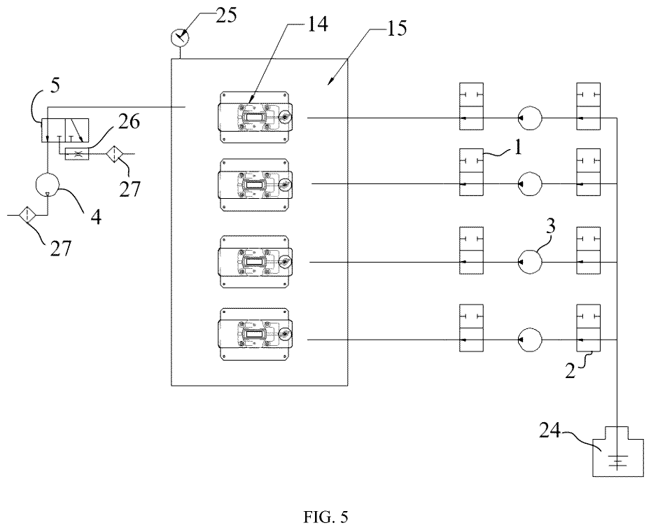

As an preferred embodiment, as shown in FIG. 5, the vacuumizing assembly further comprises a vacuum detection pressure gauge 25, a pressure-release speed regulating valve 26, and at least two gas filters 27.

The vacuum detection pressure gauge 25 is used to detect the pressure inside the vacuum tank 15; the pressure-release speed regulating valve 26 is connected with the vacuum valve 5 and is used for pressure release and adjusting the speed of the pressure releasing.

The two gas filters 27 are installed at the outlet of the vacuum pump 4 and the pressure relief port of the vacuum valve 5 respectively, to respectively prevent the volatilization of the electrochemical buffer solution to contaminate the experimental environment, and to effectively prevent dust and impurities from entering the vacuum valve 5 to cause malfunctions, as well as prevent contamination of the buffer solution inside the vacuum tank 15 when external air entering into the vacuum tank 15.

In this example, the specific type of the vacuumizing assembly is not explicitly defined, as long as fulfilling the required functions, any other types of vacuum generators may replace the vacuum pump.

As shown in FIGS. 5, 6A, 6B, and 7, the liquid injection assembly comprises an injection needle 9, an injection needle holder 10, an injection pump 3, an injection pump inlet electromagnetic valve 2, an injection pump outlet electromagnetic valve 1, a connecting tube, an adjustment screw rod 11, a guide rod 12, and a buffer solution container 24.

The injection needle 9 is mounted on the injection needle holder 10 and is used to inject the buffer solution into the inlet groove structure 1613; the injection needle holder 10 is positioned inside the vacuum tank 15.

The injection pump 3 is connected with the injection needle 9 by the connecting tube and is used to deliver the buffer solution into the injection needle 9.

the injection pump inlet electromagnetic valve 2 is connected with the inlet of the injection pump 3, and the injection pump outlet electromagnetic valve 1 is connected with the outlet of the injection pump 3.

The adjustment screw rod 11 is mounted on the injection needle holder 10 and is used to adjust the distance between the injection needle 9 and the inlet groove structure 1613.

The guide rod 12 is positioned between the chip assembly fixing plate 13 and the injection needle holder 10 to ensure the positional accuracy of the injection needle during its vertical movement.

The buffer solution container 24 is connected with the injection pump 3 by the connecting tube and is used to contain the buffer solution.

The control module can be communicated with the injection pump outlet electromagnetic valve 1, the injection pump inlet electromagnetic valve 2, vacuum valve 5, vacuum detection pressure gauge 25, and the pressure-release speed regulating valve 26 respectively.

In this example, as a preferred embodiment, four liquid injection assemblies are designed, the principle and material for each liquid injection assembly are basically same, which can be adjusted and selected based on actual needs.

In this example, as a preferred embodiment, design to simultaneously process four microwell array detection chips, once assembled, the chip assemblies are placed on the chip assembly fixing plate 13, and the fixation points are designed in a circular pattern according to the chip's structure to make full use of the planar space. The height of the injection needle above the liquid groove structure is adjusted by the adjustment screw rod 11, and the preferred height above the liquid surface is between 3 mm and 5 mm, if setting the distance too high, it can cause splashing issues, while if the distance is made too close, then it will be easily lead to the needle contacting the buffer solution, then cause crystallization, however, this height is not specifically fixed and can be adjusted and selected according to actual needs.

As shown in FIGS. 6A and 6B, the control module can comprises an electronic control board 6 for controlling the valves and a computer device (not shown in the figure) for executing computations and controls, wherein the injection pump 3, vacuum pump 4, various valves controlling the pumps, and the electronic control board 6 are all mounted on the mounting plate 7, which saves installation space and facilitates management and maintenance. The high-accuracy injection pump needs to be vertically mounted so as to facilitate discharging air.

In this example, the control module is configured to start the vacuumizing assembly when it is necessary to fill the detection chip 17 with electrochemical buffer solution, that is, start the corresponding vacuum pump 4 to discharge the air in the detection chip 17 (i.e., the air in the entire chip assembly 14), specifically, the air inside the reaction cavity 164 is discharged along the fluid channel formed by the fluid groove 16122 and through the drain holes in the inlet groove 1613, wherein, the vacuum pressure in the vacuum tank 15 is detected by the vacuum detection pressure gauge 25, and this information is fed back to the control module.

The control module is also configured to respond to detect out a preset vacuum condition being established in the chip assembly 14, or as an optional embodiment, respond to detect out the pressure inside the vacuum tank 15 reaching a predetermined value (which can be set to the system's maximum vacuum level), then start the liquid injection assembly, specifically starting the corresponding liquid injection pump 3 to inject the buffer solution into the inlet groove structure and controls the vacuumizing assembly to release pressure, and the buffer solution in the inlet groove structure flows into the reaction cavity through the fluid channel under the action of negative pressure, thereby filling the detection chip.

Wherein, the air storage chamber is used to store the residual air pushed in by the buffer solution when it flows through the fluid channel into the reaction chamber, thereby preventing interference with the operational performance of the microwell array detection chip. This air storage chamber is designed to be located at the end of the detection chip, which is a non-working area, where complete filling with buffer solution is not required, as the buffer solution is injected from front to back, the residual air is gradually pushed into the air storage chamber.

Specifically, the detection chip assembly tool can make the microwell array detection chip to form a semi-sealed cavity, utilizes a funnel-shaped exhaust port and the inlet groove structure, and start the vacuum pump to vacuumize the vacuum tank to −95 KPa to −100 KPa, to discharge the air in the microwells of the detection chip. Upon detecting that the vacuum in the vacuum tank has reached a preset condition, then the liquid injection assembly is started to inject liquid into the inlet groove structure, and when the liquid injection assembly is started, continue to start the vacuum pump to maintain a vacuum state, thereby effectively prevent bubbles being generated caused by the flow of the injected liquid.

The specific process for starting the liquid injection involves: firstly open the injection pump inlet electromagnetic valve, at which point the injection pump draws buffer solution from the buffer solution container, after a set volume of buffer solution is drawn, close the injection pump inlet electromagnetic valve, followed by opening the injection pump outlet electromagnetic valve. At this point, the injection pump dispenses the buffer solution into the inlet groove structure 1613 through the injection needle. After injecting a preset volume of buffer solution (e.g., 300 μl), the injection stops, and there is a wait for a preset period (e.g., 10 seconds), subsequently, the vacuum pump is turned off, and the pressure-release speed regulating valve is opened to release pressure so as to communicate with the atmosphere, at this point, under atmospheric pressure, the buffer solution flows into the reaction cavity, thereby filling the detection chip, additionally, the residual air with small volume during the filling process is pushed into the air storage chamber.

The electrochemical buffer solution is stored in the buffer solution container, which does not need frequent manual handling; the corresponding valves can control the opening and closing of liquid flow, ensuring a seal during the vacuum process and preventing liquid overflow; the high-precision injection pump accurately controls the volume, speed, and timing of the injection; additionally, the injection needle ensures accurate placement of the liquid and minimizes the issue of liquid retention.

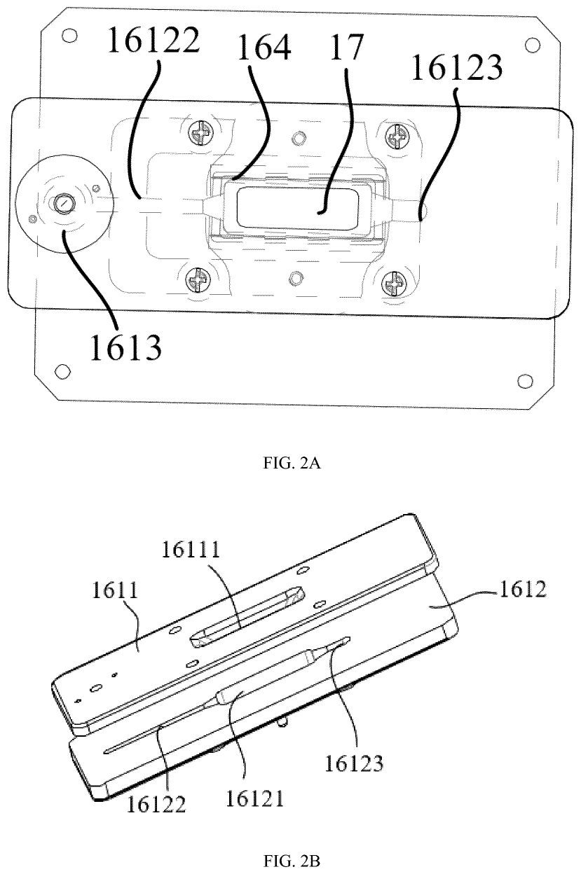

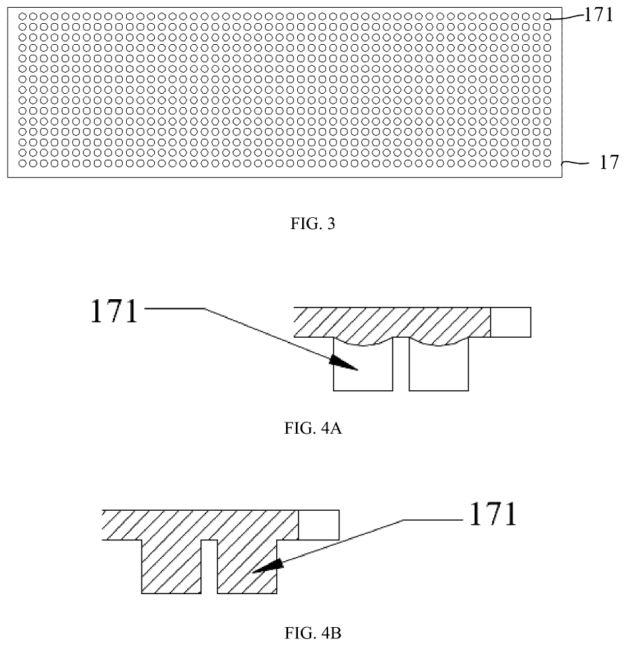

As shown in FIG. 3, the diameter of individual microwell 171 on the detection chip 17 generally ranges from several tens of micrometers to one hundred micrometers. Using traditional liquid injection methods, then the result as depicted in FIG. 4A can be observed, where the gas inside the microwells 171 cannot be discharged (unfilled parts indicate gas, and filled parts indicate liquid), preventing the liquid from filling; in contrast, the filling scenario in this example as shown in FIG. 4B, which can be seen that complete filling of the microwells 171 can be achieved.

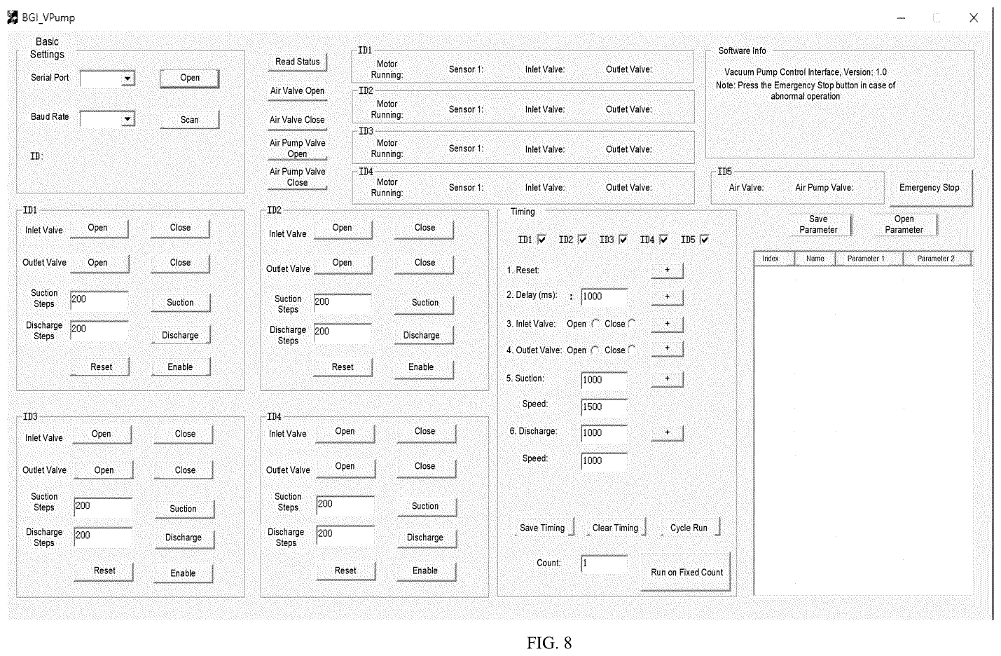

In this example, as shown in FIG. 8, using an electronic control interface, the control module is capable of executing full-process control by a single button click, after placing the chip assembly inside the vacuum tank, click a customized operation on the electronic control interface, then it can achieve automatically executing the full-process. After operation, take out the chip assembly, at this stage, the filling of electrochemical buffer solution into the microwells are completely. The control module also supports individual control, which allow to control the opening or closing for each valve body, and the running of the piston pump.

Specifically, communication between the computer device's (supervisor computer) electronic control interface and the electronic control board 6 allows for individual control of each type of valve body, or the operations can also be coordinated by autonomous timing to minimize manual involvement, users have the flexibility to choose the quantity of control channels, and define the number of operation cycles and their cycling mode by their own, thereby achieving fully automated control throughout the process. by using the mode of a supervisor computer issuing logic commands, and by communication being established with the electronic control board via high-speed data cables, the control module ensures the correctness of the issued command, so that make the electronic control board to control the corresponding components to carry out actions, so as to implement the actions such as automatic vacuumizing, automatic liquid injection, and automatic filling, ensuring the accuracy and automation of the entire process, thereby ensuring that the electrochemical buffer solution fully enters the microwell array of the detection chip, without human intervention.

In this example, it can achieve individual control for any pump or valve using a computer device, and it also can achieve one-click operation after storing logic sequences, which make the operation flexible and convenient, and each parameter can be adjusted individually.

The liquid injection apparatus for detection chips provided in this example offers beneficial effects as follows:
1. the vacuum environment effectively discharge air in the microwell array of the detection chip, and the air storage chamber can effectively prevent residual air from remaining in the microwells due to the inability of achieving an absolute vacuum, thus facilitating effective filling of the microwell array with the electrochemical buffer solution;
2. manual operation using a pipette gun is eliminated, which reduces labor cost and minimizes staff contacting with chemicals; the tip of the pipette gun is disposable consumables, while the tip is not needed in this embodiment, thus saving cost;
3. all components of the injection apparatus can be electronically controlled by the control module, a one-click operation can be performed via the electronic control interface on the client end of a computer device, which is convenient and quick, and the injection timing, speed, and volume can all be precisely controlled, thereby enhancing overall stability and effectively avoiding human error.

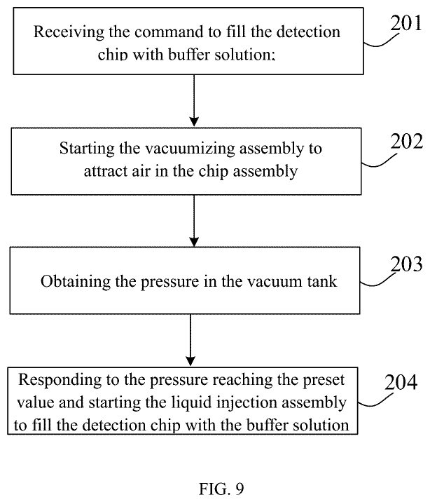

As another example, this example provides a method of injecting liquid into the detection chip, the method of injecting liquid is implemented by utilizing the liquid injection apparatus for the detection chip as described above, as shown in FIG. 9, the method of injecting liquid primarily comprises the following steps:
step 201—receiving the command to fill the detection chip with buffer solution;
step 202—starting the vacuumizing assembly to attract air in the chip assembly;
step 203—obtaining the pressure in the vacuum tank;
step 204—responding to the pressure reaching the preset value and starting the liquid injection assembly to fill the detection chip with the buffer solution.

Specifically, in step 201, when it is necessary to fill the detection chip with electrochemical buffer solution, the assembled chip assembly is placed inside the vacuum tank, and operators issue the command of filling buffer solution by the electronic control interface.

In step 202, the vacuumizing assembly is started, specifically starting the corresponding vacuum pump to discharge the air in the chip assembly.

In step 203, the pressure inside the vacuum tank is continuously detected using a vacuum detection pressure gauge, and feedback to the control module.

In step 204, in respond to detect out the pressure in the vacuum tank reaching a preset value, then liquid injection assembly is started to inject the buffer solution into the inlet groove structure and controls the vacuumizing assembly to release pressure, and the buffer solution in the inlet groove structure flows into the reaction cavity along the fluid channel under the action of negative pressure so as to fill the detection chip.

In the method of injecting liquid into the detection chip provided by this example, it effectively utilize a mode of vacuumizing followed by automatic liquid injection, which make the gas in the microwell array of the detection chip does not pass through the solution, thereby effectively preventing a gas-liquid mixture being generated, additionally, the method eliminates the need for manual operation using a pipette gun, enables automatic vacuuming, liquid injection, and pressure release can be implemented by a single button, which not only reduce cost but also minimize staff contacting with chemicals, thereby significantly improving the efficiency and accuracy of liquid injection into the detection chip.

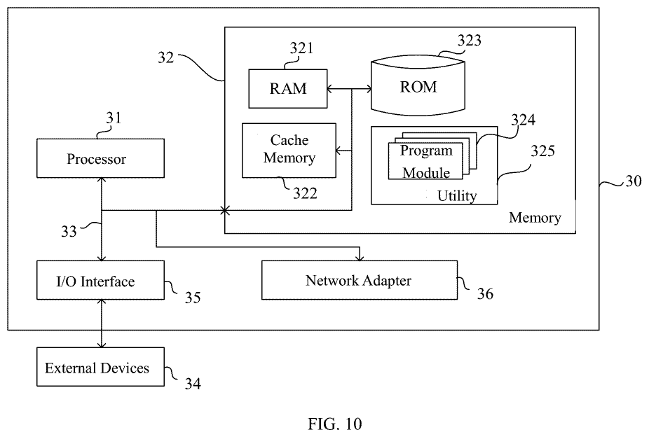

FIG. 10 is a structural schematic of an electronic device according to this example. The electronic device comprises a memory, a processor, and a computer program stored in the memory that can be run on the processor, when the processor executes the computer program, the method of injecting liquid into the detection chip, as described in the above example, is implemented. The electronic device 30 illustrated in FIG. 10 is merely an example and should not impose any limitations on the functionality and scope of use of the embodiments as described in the present application.

As shown in FIG. 10, the electronic device 30 can be presented in the form of a general computing device, such as a server. The components of the electronic device 30 may include, but are not limited to, at least one processor 31 as described above, at least one memory 32 as described above, a bus 33 that connecting various system components including the memory 32 and the processor 31.

The bus 33 includes a data bus, an address bus, and a control bus.

The memory 32 may include a volatile memory such as Random Access Memory (RAM) 321 and/or a cache memory 322, and may further include Read-Only Memory (ROM) 323.

The memory 32 may also include program/utility 325 with a set of (at least one) program modules 324, such a program module 324 comprises, but not limited to: an operating system, one or more application programs, other program modules, and program data, each example or some combination thereof may include implementations in a network environment.

The processor 31 executes the computer programs stored in the memory 32, thereby performing various functional applications and data processing, such as the method for liquid injection into a detection chip as described in the above examples of the present application.

The electronic device 30 may also communicate with one or more external devices 34 (e.g., keyboards, pointing devices, etc.). Such communication may be carried out through an input/output (I/O) interface 35. Moreover, the model-generating device 30 may also communicate with one or more networks (such as a Local Area Network (LAN), a Wide Area Network (WAN), and/or a public network, such as the Internet) via a network adapter 36. As shown in FIG. 10, the network adapter 36 communicates with other modules of the model-generating device 30 by the bus 33. It should be understood that, although not shown in the figure, other hardware and/or software modules can be used in conjunction with the model-generating device 30, including but not limited to: microcode, device drivers, redundant processors, external disk arrays, RAID (disk array) systems, tape drives, and data backup storage systems, etc.

It should be noted that although several units/modules or sub-units/modules of the electronic device are mentioned in the detailed description above, this division is merely exemplary and not mandatory. In fact, according to embodiments of the present application, the characteristics and functions of two or more of the units/modules described above can be embodied in one unit/module. Conversely, the characteristics and functions of one unit/module described above can be further divided and embodied by multiple units/modules.

This example also provides a computer-readable storage medium on which a computer program is stored. When executed by a processor, the program implements the steps of the method of injecting liquid into the detection chip as described in the above example.

Wherein, the readable storage medium can specifically include, but is not limited to, portable disks, hard disks, random access memory, read-only memory, erasable programmable read-only memory, optical storage devices, magnetic storage devices, or any appropriate combination thereof.

In a possible embodiment, the present application can also be implemented as a program product, which includes program code. When the program product is executed on a terminal device, the program code is used to enable the terminal device to perform the steps of the method for liquid injection into the detection chip as described in the above example.

Wherein, the program code can be written in any combination of one or more programming languages and can be executed entirely on a user's device, partially on a user's device, as an independent software package, partly on a user's device and partly on a remote device, or entirely on a remote device.

Although specific embodiments of the present application have been described above, it should be understood by those skilled in the art that these descriptions are merely illustrative. The scope of the present application is defined by the appended claims. Those skilled in the art can make various changes or modifications to these embodiments without departing from the principles and essence of the present application, and these changes and modifications are intended to fall in the scope of protection of the present application.

1. A detection chip assembly tool, wherein, the detection chip assembly tool is mounted on a vacuumizing assembly;
the detection chip assembly tool comprises:
a base mounted on a detection chip, the base is provided with a reaction cavity covering the detection chip and a fluid channel communicated with the reaction cavity, and is further provided with a inlet groove structure communicated with the fluid channel and having a buffer solution injected;
wherein, when the detection chip is filled with the buffer solution, the vacuumizing assembly is started to discharge air in the detection chip assembly tool, in response to the vacuumizing assembly vacuumizing, pressure relief is performed, and the buffer solution in the inlet groove structure flows into the reaction cavity along the fluid channel under the action of negative pressure so as to fill the detection chip.

2. The detection chip assembly tool according to claim 1, the base comprises a cover plate and a bottom plate, and the cover plate is mounted on the bottom plate;
the cover plate is provided with a recessed area, and the bottom plate is provided with a cut-out area, the bottom of the recessed area together with the cut-out area form the reaction cavity;
the bottom plate is provided with a fluid groove, the fluid groove together with the bottom of the cover plate form the fluid channel;
the top of the cover plate is provided with the inlet groove structure.

3. The detection chip assembly tool according to claim 2, the bottom plate is also provided with an air storage groove, and the air storage groove together with the bottom of the cover plate form an air storage chamber;
the air storage chamber is communicated with the reaction cavity and is used to store the residual air that is pushed in by the buffer solution when the buffer solution fills into the reaction cavity.

4. The detection chip assembly tool according to claim 1, the detection chip assembly tool further comprises a fixed base;
the detection chip is mounted on the fixed base.

5. A liquid injection apparatus for a detection chip, wherein, the liquid injection apparatus comprises a liquid injection assembly, a vacuumizing assembly, a control module, and the detection chip assembly tool;
the detection chip assembly tool comprises:
a base mounted on a detection chip, the base is provided with a reaction cavity covering the detection chip and a fluid channel communicated with the reaction cavity, and is further provided with a inlet groove structure communicated with the fluid channel and having a buffer solution injected;
wherein, when the detection chip is filled with the buffer solution, the vacuumizing assembly is started to discharge air in the detection chip assembly tool, in response to the vacuumizing assembly vacuumizing, pressure relief is performed, and the buffer solution in the inlet groove structure flows into the reaction cavity along the fluid channel under the action of negative pressure so as to fill the detection chip;
the detection chip assembly tool is mounted on the vacuumizing assembly, and the liquid injection assembly is used to inject buffer solution into the inlet groove structure;
the control module is configured to start the vacuumizing assembly to discharge air in the detection chip assembly tool when filling the detection chip with buffer solution;
the control module is also configured to respond to detect out a preset vacuum condition being established in the detection chip assembly tool, then start the liquid injection assembly to inject the buffer solution into the inlet groove structure and control the vacuumizing assembly to release pressure, and the buffer solution in the inlet groove structure flows into the reaction cavity along the fluid channel under the action of negative pressure so as to fill the detection chip.

6. The liquid injection apparatus for the detection chip according to claim 5, the vacuumizing assembly comprises a chip assembly fixing plate, a vacuum tank, a vacuum tank cover plate, a suction pipeline, a vacuum pump, and a vacuum valve;
the detection chip assembly tool is mounted on the chip assembly fixing plate;
the chip assembly fixing plate is installed inside the vacuum tank;
the vacuum tank cover plate is mounted on the vacuum tank;
one end of the suction pipeline is positioned inside the vacuum tank;
the vacuum pump is installed on the suction pipeline and is used to extract air in the vacuum tank;
the vacuum valve is connected with the vacuum pump and is communicated with the control module.

7. The liquid injection apparatus for the detection chip according to claim 6, the vacuumizing assembly further comprises a vacuum detection pressure gauge, a pressure-release speed regulating valve, and a gas filter;
the vacuum detection pressure gauge is communicated with the control module and is used to detect the pressure inside the vacuum tank;
the pressure-release speed regulating valve is connected with the vacuum valve and is used to release pressure and adjust the speed of the pressure releasing;
the gas filter is installed on the suction pipeline.

8. The liquid injection apparatus for the detection chip according to claim 6, the liquid injection assembly comprises an injection needle, an injection needle holder, an injection pump, an injection pump inlet electromagnetic valve, an injection pump outlet electromagnetic valve, and a connecting tube;
the injection needle is mounted on the injection needle holder and is used to inject the buffer solution into the inlet groove structure;
the injection needle holder is positioned inside the vacuum tank;
the injection pump is connected with the injection needle by means of the connecting tube and is used to deliver buffer solution into the injection needle;
the injection pump inlet electromagnetic valve is connected with the inlet of the injection pump and is communicated with the control module;
the injection pump outlet electromagnetic valve is connected with the outlet of the injection pump and is communicated with the control module.

9. The liquid injection apparatus for the detection chip according to claim 8, the liquid injection assembly further comprises an adjustment screw rod and a guide rod;
the adjustment screw rod is configured on the injection needle holder and is used to adjust the distance between the injection needle and the inlet groove structure;
the guide rod is positioned between the chip assembly fixing plate and the injection needle holder.

10. The liquid injection apparatus for the detection chip according to claim 8, the liquid injection assembly further comprises a buffer solution container;
the buffer solution container is connected with the injection pump by means of the connecting tube and is used to contain the buffer solution.

11. A method of injecting liquid into a detection chip, wherein, the method of injecting liquid utilizes a liquid injection apparatus for the detection chip;
the liquid injection apparatus comprises a liquid injection assembly, a vacuumizing assembly, a control module, and a detection chip assembly tool;
the detection chip assembly tool comprises:
a base mounted on a detection chip, the base is provided with a reaction cavity covering the detection chip and a fluid channel communicated with the reaction cavity, and is further provided with a inlet groove structure communicated with the fluid channel and having a buffer solution injected;
wherein, when the detection chip is filled with the buffer solution, the vacuumizing assembly is started to discharge air in the detection chip assembly tool, in response to the vacuumizing assembly vacuumizing, pressure relief is performed, and the buffer solution in the inlet groove structure flows into the reaction cavity along the fluid channel under the action of negative pressure so as to fill the detection chip;
the detection chip assembly tool is mounted on the vacuumizing assembly, and the liquid injection assembly is used to inject buffer solution into the inlet groove structure;
the control module is configured to start the vacuumizing assembly to discharge air in the detection chip assembly tool when filling the detection chip with buffer solution;
the control module is also configured to respond to detect out a preset vacuum condition being established in the detection chip assembly tool, then start the liquid injection assembly to inject the buffer solution into the inlet groove structure and control the vacuumizing assembly to release pressure, and the buffer solution in the inlet groove structure flows into the reaction cavity along the fluid channel under the action of negative pressure so as to fill the detection chip;
and the method of injecting liquid comprises:
start the vacuumizing assembly to discharge air in the detection chip assembly tool when the detection chip is filled with buffer solution;
respond to detect out a preset vacuum condition being established in the detection chip assembly tool, then start the liquid injection assembly to inject buffer solution into the inlet groove structure and control the vacuumizing assembly to release pressure, and the buffer solution in the inlet groove structure flows into the reaction cavity along the fluid channel under the action of negative pressure so as to fill the detection chip.

12. An electronic device, comprising a memory, a processor, and a computer program stored in the memory that can be run on the processor, wherein, when the processor executes the computer program, the method of injecting liquid into the detection chip according to claim 11 is implemented.

13. A computer-readable medium having a computer instruction stored herein, wherein, when the computer instruction is executed by a processor, the method of injecting liquid into the detection chip according to claim 11 is implemented.

14. The detection chip assembly tool according to claim 2, the detection chip assembly tool further comprises a fixed base;
the detection chip is mounted on the fixed base.

15. The detection chip assembly tool according to claim 3, the detection chip assembly tool further comprises a fixed base;
the detection chip is mounted on the fixed base.

16. The liquid injection apparatus for the detection chip according to claim 5, the base comprises a cover plate and a bottom plate, and the cover plate is mounted on the bottom plate;
the cover plate is provided with a recessed area, and the bottom plate is provided with a cut-out area, the bottom of the recessed area together with the cut-out area form the reaction cavity;
the bottom plate is provided with a fluid groove, the fluid groove together with the bottom of the cover plate form the fluid channel;
the top of the cover plate is provided with the inlet groove structure.

17. The liquid injection apparatus for the detection chip according to claim 5, the bottom plate is also provided with an air storage groove, and the air storage groove together with the bottom of the cover plate form an air storage chamber;
the air storage chamber is communicated with the reaction cavity and is used to store the residual air that is pushed in by the buffer solution when the buffer solution fills into the reaction cavity.

18. The liquid injection apparatus for the detection chip according to claim 5, the detection chip assembly tool further comprises a fixed base;
the detection chip is mounted on the fixed base.
